(19) United States
(12) Patent Application Publication
(10) Pub. No.: US 2009/0214883 A1
(43) Pub. Date: Aug. 27, 2009

(54) CHROMIUM-FREE, THERMALLY CURABLE CORROSION PROTECTION COMPOSITION

(76) Inventors: Ard De Zeeuw, Dusseldorf (DE); Marcel Roth, Dusseldorf (DE); Jorg Sander, Velbert (DE)

Correspondence Address: Henkel Corporation, 10 Finderne Avenue, Bridgewater, NJ, 08807, US

(21) Appl. No.: 12/390,770

(22) Filed: Feb. 23, 2009

Related U.S. Application Data
(63) Continuation of application No. PCT/EP2007/055214, filed on May 30, 2007.

(30) Foreign Application Priority Data
Aug. 24, 2006 (DE) 102006039633.2

(51) Int. Cl. C23F 11/00; B05D 3/00; B32B 15/09

(52) U.S. Cl. 428/458; 252/389.1; 252/389.23; 252/389.53; 252/389.61; 252/389.54; 252/389.52; 427/388.2

(57) ABSTRACT

Chromium-free, curable corrosion protection composition for primary coating of metallic substrates, which has a pH in the range from 1 to 3 and contains water and a) fluorocomplex ions of titanium and/or zirconium, b), at least one corrosion protection pigment, c) at least one organic polymer which is soluble or dispersible in water in the specified pH range and on its own in aqueous solution at a concentration of 50% by weight has a pH in the range from 1 to 3, process for treating metal strip with this composition and treated metal strip which can be obtained in this way. The organic polymer c) is preferably selected so that it contains at least one monomer selected from among acrylic acid, methacrylic acid, acrylic esters and methacrylic esters as free-radically polymerizable, ethylenically unsaturated monomers and has at least one type of functional groups selected from among epoxy, silane, hydroxy, carboxyl, phosphoric acid and phosphoric ester groups.

The present invention relates to a chromium-free organic/inorganic corrosion protection composition and a method for corrosion protection for treating steel surfaces that are coated with zinc or zinc alloys or with aluminum or aluminum alloys, surfaces of zinc or of zinc alloys, aluminum or aluminum alloys. It is particularly suitable for the surface treatment in coil coating for the application of these substrates in household and architectural segments as well as in the automobile industry.

A chromium-free aqueous corrosion protection composition for the treatment of galvanized or alloy galvanized steel surfaces as well as aluminum surfaces is described in WO 99/29927. The composition comprises hexafluoro anions of titanium and/or zirconium, vanadium ions, cobalt ions, phosphoric acid as the essential components as well as preferably an organic film-former, especially based on polyacrylate. This corrosion protection composition is particularly suitable for the anti-corrosion treatment of metal strips.

DE 199 23 048 (WO 00/71629) discloses a chromium-free anti-corrosive composition, comprising water and
a.) 0.5 to 100 g/l hexafluoro anions of titanium (IV), silicon (IV) and/or zirconium (IV)
b.) 0 to 100 g/l phosphoric acid
c.) 0 to 100 g/l of one or a plurality of compounds of cobalt, nickel, vanadium, iron, manganese, molybdenum or tungsten,
d.) 0.5 to 30 wt. % of at least one water-soluble or water-dispersible film-forming organic polymer or copolymer (based on the active substance),
e.) 0.1 to 10 wt. % of an organo phosphonic acid
f.) optional additional auxiliaries and additives.

A further subject of the cited document relates to a method for the anti-corrosion treatment of steel that is optionally provided with a metallic coating of zinc, aluminum, copper, nickel or similar metals, or aluminum or its alloys, said method comprising the following essential steps:
a) the surface of the substrate is brought into contact with a corrosion protection composition from the above prior art for a time between 0.5 and 60 seconds at a treatment temperature between 10 and 50° C., preferably 15 and 35° C.; the treatment temperature can be adjusted by means of heat transfer through the work piece or the treatment solution,
b) the excess corrosion protection composition is optionally removed from the surface and
c) heating for a time of 1 to 120 seconds is made by suitable heat transfer, wherein peak metal temperatures between 50° C. and 150° C. are intended to be attained, wherein a simultaneous crosslinking of the polymer film and its attachment onto the metal surface occur.

The present invention develops the prior art. In a first aspect it relates to a chromium-free, curable corrosion protection composition for the primary coating of metallic substrates, said composition having a pH in the range 1 to 3, comprising water and
a) complex fluoro ions of titanium and/or zirconium,
b) at least one corrosion protection pigment,
c) at least one organic polymer that is water-soluble or water-dispersible in the cited pH range and which, as such in aqueous solution at a concentration of 50 wt. %, exhibits a pH in the range 1 to 3.

A “primary coating” means that the metallic substrate was not subjected to any other corrosion protection treatment prior to the contact with the corrosion protection composition according to the invention. In fact, the corrosion protection composition according to the invention should be applied onto a freshly produced or freshly cleaned metal surface. This treatment illustrates the primary or the sole corrosion protection measure for the metallic substrate. After the application of the corrosion protection composition according to the invention it is absolutely possible to superimpose additional decorative and/or corrosion protective coatings such as for example conventional dip paints, spray paints or powder paints.

The complex fluoro ions of titanium and/or zirconium preferably represent the complex hexafluoro ions. They can be introduced in the form of free acids or in the form of their salts that are soluble in the corrosion protection composition. In order to adjust the acidic pH, the complex fluoro ions are advantageously introduced as the hexafluoro acids. The complex fluoro ions in the composition may also possess less than 6 fluorine atoms per complex molecule. This can be accomplished for example by introducing, in addition to complex hexafluoro ions, further compounds or salts with titanium and/or zirconium ions that are able to form fluoro complexes. Oxycarbonates or hydroxycarbonates may be cited for example. Having said that, the corrosion protection composition can possess an excess of fluoride ions over and above the presence of complex hexafluoro ions and which can be introduced for example in the form of hydrofluoric acid.

The corrosion protection pigment b) is preferably a particulate organic or inorganic compound (barrier pigment) that impedes the diffusion of water and/or other corrosive agents through the coating or can release the anti-corrosively acting molecules or ions. A compound with cation exchange properties is preferably used as the corrosion protection pigment. A compound that comprises cations of divalent or higher valent metals through the exchange of alkali metal ions is particularly preferred. Preferred exchangeable cations are the cations of Ca, Ce, Zn, Sr, La, Y, Al and Mg. Corrosion protection pigments based on silicates with a layer structure or a spatial cellular structure, which comprise such types of exchangeable cations, are particularly preferred. For example, the corrosion protection pigment can be a synthetic, amorphous silica that exists at least partially in the form of its salt with exchangeable calcium ions. In order to correspond to the aim layer thickness (see below) of the cured corrosion protection composition, the average particle size of the corrosion protection pigment (D₅₀, determined for example by light scattering methods) is in the range 0.5 to 10 μm, particularly in the range 1 to 4 μm.

The organic polymer to be selected as the component c) has the intrinsic property of a pH in the range 1.5 to 2.5 and particularly in the range 1.8 to 2.2 in aqueous solution at a concentration of about 50 wt. %. For this it is required that the polymer carries groups that react with acids in aqueous solution, that confer a pH in the cited range to the polymer solution, without the need for the pH to be adjusted by the addition of additional acid. This will be described in more detail further below.

The presence of the component c) renders the corrosion protection composition “curable”, i.e. ensures that the corrosion protection composition attaches itself to the metal surface. This attachment can occur purely physically by evaporating off water and/or solvent (this can be called “film casting”). However, the curing at least partially involves a chemical reaction (“crosslinking”), in which the molecular weight of the polymer c) increases. Examples of such reactions are polymerization reactions, for example through C═C double bonds, or condensation reactions. These reactions can be initiated by heat or by the action of energy-rich radiation (e.g. electron beam radiation, gamma radiation, UV or visible radiation). In the context of the present invention, a heat curable polymer and/or a polymer that can be cured by evaporating off water and/or solvent are preferably employed as the component c). The heat input can result from a heat transfer medium (such as for example the pre-heated substrate or hot air) or by infrared radiation.

The corrosion protection composition preferably comprises phosphate ions as the additional component d). They can be added in the form of phosphoric acid and/or in the form of its salts. When adding phosphoric acid, it may be necessary to adjust the pH of the corrosion protection composition to the required range by adding basic substances. Oxides or carbonates of the metals cited below may be used as the basic substances in so far as the presence of the corresponding metal ions is desired. Independently of the form of the introduced phosphate ions, the corresponding equilibrium between the differently protonated phosphate ion species will adjust itself in the treatment composition according to its pH. For the purposes of simplicity, for the following quantitative data shown below for the preferred composition of the corrosion protection composition, it is assumed that the phosphate ions are present in the form of phosphoric acid.

Moreover, the corrosion protection composition according to the invention can comprise manganese ions and/or magnesium ions as the additional component e). The presence of manganese ions is preferred. In this case, magnesium ions can be present in addition to the manganese ions and is preferred. These metal ions are preferably introduced into the corrosion protection composition as the phosphates that are obtained by treating oxides, hydroxides or carbonates of these metals with phosphoric acid. These oxides, hydroxides or carbonates can also serve as the basic components in order to adjust the pH to the desired range in the presence of phosphoric acid.

Moreover the corrosion protection composition according to the invention preferably comprises at least one organic compound as the component f) that is capable of forming chelate complexes Exemplary organic compounds (molecules or ions) that are capable of forming chelate complexes are amino alkylene phosphono acids, especially amino methylene phosphono carboxylic acids, phosphono carboxylic acids, geminal diphosphonic acids and esters of phosphoric acid as well as in each case their salts. Selected examples are phosphono butane tricarboxylic acid, amino tris-(methylene phosphonic acid), diethylenetriaminepenta(methylene phosphonic acid), (2-hydroxyethyl)amino bis(methylene phosphonic acid), ethylenediaminetetrakis-(methylene phosphonic acid), hexamethylenediaminetetrakis(methylene phosphonic acid), (2-ethylhexyl)-amino bis(methylene phosphonic acid), n-octylamino bis-(methylene phosphonic acid), cyclohexane-1,2-diamine tetrakis(methylene phosphonic acid), pentaethylenehexamine octakis(methylene phosphonic acid), N,N-bis(3-aminopropyl)amino hexakis(methylene phosphonic acid).

Further practical examples are:
1-Hydroxy-1-phenylmethane-1,1-diphosphonic acid
p-Hydroxyphenyl-1-amino methane-1,1-diphosphonic acid
1-Hydroxy-1-phenylmethane-1,1-diphosphonic acid
1-Amino-1-phenylmethane-1,1-diphosphonic acid
4-Aminophenyl-1-hydroxymethane-1,1-diphosphonic acid
p-Aminophenyl-1-amino methane-1,1-diphosphonic acid
p-Chlorophenylmethane-1,1-diphosphonic acid
1-Chloro-1-phenylmethane-1,1-diphosphonic acid
p-Chlorophenyl-1-hydroxymethane-1,1-diphosphonic acid
1-Chlorophenylmethane-1,1-diphosphonic acid
p-Chlorphenyl-1-chloromethane-1,1-diphosphonic acid
4-Chlorophenyl-1-chloromethane diphosphonic acid
p-Hydroxyphenylamino methylene diphosphonic acid
3,4-Dimethylphenyl-1-chloromethane diphosphonic acid
3,4-Dimethylphenyl-1-hydroxymethane diphosphonic acid
3,4-Dimethylphenylamino methane diphosphonic acid
3,4-Dimethylphenyl-1-chloromethane-1,1-diphosphonic acid
4-Dimethylaminophenyl-1-hydroxymethane diphosphonic acid
4-(N-benzyl-N,N-dimethylamino)-phenyl-1-hydroxymethane diphosphonic acid
4-Trimethylaminophenyl-1-hydroxymethane diphosphonic acid
3,4,5-Trimethoxyphenyl-1-amino methane-1,1-diphosphonic acid
1-Bis-(N-hydroxymethyl)-amino-1-phenylmethane-1,1-diphosphonic acid
3,5-Dichloro-4-hydroxyphenyl-hydroxymethane diphosphonic acid
3,5-Dibromo-4-hydroxyphenyl-amino methane diphosphonic acid
1-Amino-1-cyclohexylmethane-1,1-diphosphonic acid
1-Hydroxy-1-cyclohexylmethane-1,1-diphosphonic acid
[4-(Aminomethyl)-cyclohexyl]-1-hydroxymethane-1,1-diphosphonic acid
N-(Hydroxymethyl)-1-amino ethane-1,1-diphosphonic acid
1,3-Diamino propane-1,1-diphosphonic acid
3-Dimethylamino-1-amino propane-1,1-diphosphonic acid
3-Monomethylamino-1-amino propane-1,1-diphosphonic acid
3-(N-Dodecylamino)-1-amino propane-1,1-diphosphonic acid
3-(N,N-Dodecylmethylamino)-1-amino propane-1,1-diphosphonic acid
3-(N-Dimethyldodecylamino)-1-amino propane-1,1-diphosphonic acid
2-Amino-2-methyl-1-hydroxypropane-1,1-diphosphonic acid
3-Amino-1-hydroxy-3-phenylpropane-1,1-diphosphonic acid
3-Amino-3-phenyl-1-hydroxypropane-1,1-diphosphonic acid
3-Diethylamino-1-hydroxypropane-1,1-diphosphonic acid
3-N,N-Dimethylamino-1-hydroxypropane-1,1-diphosphonic acid
3-N-bis-(hydroxyethyl)-amino-1-hydroxypropane-1,1-diphosphonic acid
3-(N-Dodecylamino)-1-hydroxypropane-1,1-diphosphonic acid
1,3-Dihydroxy-3-phenylpropane-1,1-diphosphonic acid
3-Dimethylamino-1-hydroxypropane-1,1-diphosphonic acid
1,3-Dihydroxypropane-1,1-diphosphonic acid
1-Hydroxy-3-diethylamino propane-1,1-diphosphonic acid
1,3-Dihydroxy-3-phenylpropane-1,1-diphosphonic acid
1,3-Diamino butane-1,1-diphosphonic acid
1-Hydroxy-3-amino butane-1,1-diphosphonic acid
3-Monoethylamino-1-amino butane-1,1-diphosphonic acid
4-Amino-1-hydroxybutane-1,1-diphosphonic acid
4-N,N-Dimethylamino-1-hydroxybutane-1,1-diphosphonic acid
6-Amino-1-hydroxyhexane-1,1-diphosphonic acid
1,6-Dihydroxyhexane-1,1-diphosphonic acid
1,11-Dihydroxyundecane-1,1-diphosphonic acid
11-Amino-1-hydroxyundecane-1,1-diphosphonic acid
1,2-Diaminocyclohexanetetrakis(methylene phosphonic acid)
Glucamine-bis(methylene phosphonic acid)
1-Ureido ethane-1,1-diphosphonic acid
Pyrimidyl-2-amino methane diphosphonic acid
Pyrimidyl-2-amino methylene diphosphonic acid
N,N′-Dimethylureido methane diphosphonic acid
N-(2-Hydroxyethyl)ethylenediamine-N,N′,N′-trismethylene phosphonic acid
Amino acetic acid-N,N-dimethylene phosphonic acid
1,2-Diamino propanetetrakis(methylene phosphonic acid)
2-Hydroxypropane-1,3-diaminetetrakis(methylene phosphonic acid)
5-Hydroxy-3-oxa-1-amino pentane-bis(methylene phosphonic acid)
Imino bis(methylene phosphonic acid)
γ,γ-Diphosphono-N-methyl butyrolactam
Amidino methylene diphosphonic acid
Formylamino methane diphosphonic acid
2-Imino piperidone-6,6-diphosphonic acid
2-Imino pyrrolidone-5,5-diphosphonic acid
N,N′-Dimethylimino pyrrolidone-5,5-diphosphonic acid
1-Methyl-2-pyrrolidone-5,5-diphosphonic acid
Amino diacetic acid-N-methylphosphonic acid
1,3-Dihydroxy-2-methylpropane-N,N-dimethylene phosphonic acid
1,2-Dihydroxypropane-3-amino-bis(methylene phosphonic acid)
2-Hydroxypropane-1,3-diaminetetrakis(methylene phosphonic acid)
3,6-Dioxa-1,8-diamino octane-tetrakis(methylene phosphonic acid)
1,5-Diamino pentanetetrakis(methylene phosphonic acid)
Methylamino dimethylene phosphonic acid
N-Hexylamino dimethylene phosphonic acid
decylamino dimethylene phosphonic acid
3-Picolylamino dimethylene phosphonic acid
Methane diphosphonic acid
Dichloromethane diphosphonic acid
Tetraisopropyl ester of dichloromethane diphosphonic acid
1,1-Diphosphonoethane-2-carboxylic acid
Ethane-1,1-diphosphonic acid
Ethane-1,1,2-triphosphonic acid
1,2-Diphosphonoethane-1,2-dicarboxylic acid
Ethane-1,1,2,2-tetraphosphonic acid
1-Phosphonoethane-1,2,2-tricarboxylic acid
Phosphonoacetic acid
α-chloro-α-phosphonoacetic acid
1-phosphonopropane-2,3-dicarboxylic acid
1-phosphonopropane-1,2,3-tricarboxylic acid
propane-1,1,3,3-tetraphosphonic acid
amino methane diphosphonic acid
dimethylamino methane diphosphonic acid
N-decylamino methane-1,1-diphosphonic acid;
N-decylamino methane diphosphonic acid
N,N-dimethylamino methane diphosphonic acid
dimethylamino methane diphosphonic acid
1-amino ethane-1,1-diphosphonic acid
1-amino-2-chloroethane-1,1-diphosphonic acid
1-amino-2-phenylethane-1,1-diphosphonic acid
1-monomethylaminoethane-1,1-diphosphonic acid
N-monohydroxymethylamino ethane-1,1-diphosphonic acid
1-amino propane-1,1-diphosphonic acid
1-amino propane-1,1,3-triphosphonic acid
1-amino butane-1,1-diphosphonic acid
1-amino hexane-1,1-diphosphonic acid
1-amino decane-1,1-diphosphonic acid
1-amino hexadecane-1,1-diphosphonic acid
1-hydroxy-3,6,9-trioxadecane-1,1-diphosphonic acid
coco alkylamino bis(methylene phosphonic acid)
4-ethyl-4-methyl-3-oxo-1-aminohexane-1,1-diphosphonic acid
1-hydroxy3-oxo-4-ethyl-4-methylhexane-1,1-diphosphonic acid
1-amino-4-ethyl-4-methyl-3-oxohexane-1,1-diphosphonic acid
1-hydroxy-3-oxo-4-ethyl-4-methylhexane-1,1-diphosphonic acid
4-ethyl-4-methyl-3-oxohex-1-ene-1,1-diphosphonic acid
4-methyl-4-ethyl-3-oxohex-1-ene-1,1-diphosphonic acid
1-amino-3-oxo-4,4-dimethylheptane-1,1-diphosphonic acid
1-hydroxy-3-oxo-4,4-dimethylheptane-1,1-diphosphonic acid
4,4-dimethyl-3-oxo-hept-1-ene-1,1-diphosphonic acid
4,4-dimethyl-3-oxo-hept-1-ene-1,1-diphosphonic acid
1-amino-3-oxo-4,4-dimethyldecane-1,1-diphosphonic acid
N-ethylamino (phenylmethane diphosphonic acid)
1 -hydroxyethane-1,1-diphosphonic acid
2-[benzimidazolyl-(2,2)-]-ethane diphosphonic acid;
2-[benzimidazolyl-(2,2)-]-ethane diphosphonic acid
N-carboxymethane-1-amino ethane-1,1-diphosphonic acid
1,5-diamino pentane-1,1,5,5-tetraphosphonic acid
α-octadecyl-phosphonosuccinic acid
α-N-dodecylamino benzylphosphonic acid
β-trifluoromethyl-β-phosphonobutyric acid
1-decylpyrrolidone-2,2-diphosphonic acid pyrrolidone-5,5-diphosphonic acid
2,2-diphosphono-N-decylpyrrolidone
γ,γ-diphosphono-N-methyl butyrolactam
benzene phosphonous acid
1,4-thiazine dioxide-N-methane diphosphonic acid
p-(1,4-thiazine dioxide)-N-phenylene-hydroxymethane diphosphonic acid
α-(1,4-thiazine dioxide)-N-ethane-α,α-diphosphonic acid
3-(1,4-thiazine dioxide)-N-1-hydroxypropane-1,1-diphosphonic acid
6-(1,4-thiazine dioxide)-N-1-hydroxyhexane-1,1-diphosphonic acid
11-(1,4-thiazine dioxide)-N-1-hydroxyundecane-1,1-diphosphonic acid
azacyclopentane-2,2-diphosphonic acid
N-methylazacyclopentane-2,2-diphosphonic acid
N-decylazacyclopentane-2,2-diphosphonic acid
N-tetradecylazacyclopentane-2,2-diphosphonic acid
azacyclohexane-2,2-diphosphonic acid
1-(4,5-dihydro-3H-pyrrole-2-yl)-pyrrolidinylidene-2,2-diphosphonic acid
hydroxymethane diphosphonic acid
1-oxaethane-1,2-diphosphonic acid
1-hydroxypropane-1,1-diphosphonic acid
1-hydroxybutane-1,1-diphosphonic acid
1-hydroxypentane-1,1-diphosphonic acid
1-hydroxyoctane-1,1-diphosphonic acid.

It is further preferred that the corrosion protection composition additionally comprises molybdate ions and/or tungstate ions as the component g). They are preferably incorporated as the ammonium salts or alkali metal salts.

Moreover, it is preferred that the corrosion protection composition additionally comprises at least one cation selected from zinc, cobalt, nickel, vanadium and iron ions as the component h). Dissolved ions are meant by this in the corrosion protection compositions and not those ions that are bound in the corrosion protection pigment b) as the exchangeable cations. These cations, like the manganese ions and/or the magnesium ions cited previously, are also preferably introduced as phosphates. Once again this can occur by treating oxides, hydroxides or carbonates of these ions with phosphoric acid. In particular the corrosion protection composition preferably comprises zinc ions.

Moreover, it is preferred that the corrosion protection composition additionally comprises at least one reducing agent as the component i) selected from iron (II) ions and hydroxylamine, hydroxylammonium salts or hydroxylamine-releasing compounds. This is particularly the case when the corrosion protection composition comprises manganese (II) ions.

By definition, the corrosion protection composition comprises at least the components a), b) and c). Each of the single additional facultative components d) to i) improves specific properties in the property profile of the corrosion protection composition according to the invention. Accordingly, it is particularly preferred that the corrosion protection composition comprises at least one, preferably at least 2 and especially at least 3 of the facultative components d) to i). For example, it is particularly preferred that the corrosion protection composition comprises phosphate ions as well as manganese ions and/or magnesium ions. Moreover, it is preferred that the corrosion protection composition simultaneously comprises phosphate ions and at least one organic compound that is capable of forming chelate complexes. In a further preferred embodiment, the corrosion protection composition comprises manganese ions and/or magnesium ions and additionally at least one cation selected from zinc, cobalt, nickel, vanadium and iron ions. In so far as manganese (II) ions are present, then the corrosion protection composition preferably further comprises a reducing agent i).

In a further preferred embodiment, the corrosion protection composition comprises at least one of the components d), e), f) and h) together with molybdate ions and/or tungstate ions.

A particularly preferred corrosion protection composition comprises at least one representative of each of the components d), e), f), g) and h).

The organic polymer c) comprises simply radically polymerisable, ethylenically unsaturated monomers.

For example, the following ethylenically unsaturated monomers can be used: vinylaromatic monomers, such as styrene and α-methylstyrene, esters of preferably α,β-monoethylenically unsaturated monocarboxylic acids and dicarboxylic acids containing 3 to 6 carbon atoms, such as in particular acrylic acid, methacrylic acid, maleic acid, fumaric acid and itaconic acid, with alkanols that generally contain 1 to 12, preferably 1 to 8 carbon atoms, such as particularly the methyl-, ethyl-, n-butyl-, isobutyl-, pentyl-, hexyl-, heptyl-, octyl-, nonyl-, decyl- and 2-ethylhexylesters of acrylic and methacrylic acids, dimethyl- or di-n-butyl esters of fumaric acid and maleic acid.

Furthermore, monomers with a plurality of ethylenically unsaturated double bonds can be employed. Examples are alkylene glycol diacrylates and -dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate as well as divinylbenzene, vinyl methacrylate, vinyl acrylate, allyl methacrylate, allyl acrylate, diallyl maleate, diallyl fumarate, methylene bisacrylamide, cyclopentadienyl acrylate, triallylcyanurate or triallylisocyanurate.

The organic polymer c) preferably comprises at least one monomer selected from acrylic acid, methacrylic acid, acrylic acid esters and methacrylic acid esters, and possesses at least one type of functional group selected from epoxy, silane, hydroxy, carboxyl, phosphoric acid and phosphoric acid ester groups.

It is particularly preferably constructed such that it comprises at least two monomers selected from acrylic acid, methacrylic acid, acrylic acid esters and methacrylic acid esters, wherein at least one monomer selected from acrylic acid esters and methacrylic acid esters is contained and wherein the polymer possesses at least one type of functional group selected from epoxy, silane, hydroxy, carboxyl, phosphoric acid and phosphoric acid ester groups.

In this regard, polymers are preferred that carry phosphoric acid groups or phosphoric acid ester groups. Here it is preferred that the monomer fraction carrying phosphoric acid groups or phosphoric acid ester groups is in the range 0.5 to 4, preferably in the range 1 to 2 mol %. Preferably, in addition to the phosphoric acid groups or phosphoric acid ester groups, at least one further group, selected from epoxy groups, silane groups, carboxyl groups and hydroxyl groups, is present in the polymer Here, the hydroxyl group content in the polymer can be 0.5 to 3.5 g/kg polymer. A particularly preferred polymer comprises phosphoric acid groups or phosphoric acid ester groups, carboxyl groups and hydroxyl groups.

Moreover, it is preferred that apart from hydroxyl groups, carboxyl groups, phosphoric acid groups or phosphoric acid ester groups, the polymer additionally possesses carboxylic acid amide groups, wherein at least one hydroxyalkyl group, preferably at least one hydroxymethyl group, is bonded to the nitrogen atom of the carboxylic acid amide group. In particular, polymers are preferred that possess phosphoric acid groups or phosphoric acid ester groups and in addition not only hydroxyl groups but also carboxyl groups as well as the cited carboxylic acid amide groups.

Examples of such monomers are the C1-C8 hydroxyalkyl esters of methacrylic acid and acrylic acid such as n-hydroxyethyl, n-hydroxypropyl or n-hydroxybutyl acrylate and methacrylate as well as compounds such as n-methylolacrylamide, glycidyl methacrylate and phosphoric acid esters of hydroxyacrylates and hydroxymethacrylates.

An addition of organic compounds f) that are capable of forming chelate complexes is in principle then advisable when polymer c) does not possess any silane groups.

In addition, apart from this essential polymer c), further polymers can be present that have the particular role of improving the compatibility with specific top coats. Examples are further polymers containing OH groups as well as polymers of the polyurethane, the polyester and the epoxy type. The proportion of these additional polymers relative to the total polymer content of the corrosion protection composition can range from 1 to 20 wt. %.

In addition, the corrosion protection composition can comprise dispersing additives such as for example those known for grinding pigment pastes for the manufacture of paints.

The corrosion protection composition comprises, in the ready-for-use state, the components in the following proportions in wt. % based on the total corrosion protection composition: Water: 25 to 69.7 wt. %,
a) Fluoro complex ions of titanium and/or zirconium, calculated as the hexafluoro titanic acid or hexafluoro zirconic acid: 0.3 to 3 wt. %, preferably 0.5 to 2 wt. %,
b) Corrosion inhibiting pigment(s): in total, 5 to 25 wt. %, preferably 10 to 20 wt. %,
c) Organic polymer that is water-soluble or water-dispersible in the cited pH range and which, as such in aqueous solution at a concentration of 50 wt. %, exhibits a pH in the range of 1 to 3: 25 to 50 wt. %, preferably 30 to 40 wt. %,
d) Phosphate ions calculated as phosphoric acid: 0 to 5 wt. %, preferably 0.5 to 4 wt. %,
e) Manganese ions and/or magnesium ions: in total 0 to 2 wt. %, preferably 0.1 to 1 wt. %,
f) Organic compound(s) that is (are) capable of forming chelate complexes: in total 0 to 0.5 wt. %, preferably 0.5 to 3 wt. %,
g) Molybdate ions and/or tungstate ions calculated as the ammonium salt: in total 0 to 1 wt. %, preferably 0.05 to 0.5 wt. %,
h) Cations selected from zinc, cobalt, nickel, vanadium and iron: in total 0 to 1 wt. %, preferably 0.05 to 0.5 wt. %,
i) Reducing agent selected from iron (II) ions and hydroxylamine, hydroxyl ammonium salts or compounds that can split off hydroxylamine: in total, 0 to 0.1 wt. %, preferably 0.005 to 0.05 wt. %.

Further auxiliaries or additives can be present in addition to these components, for example the additional polymers cited above and/or dispersing additives. Naturally, the fractions of the individual components are to be chosen such that they add up to 100%. This is also true when further components in addition to the cited components a) to i) are present. In a preferred embodiment, the corrosion protection composition exclusively comprises water as well as the components a) to c) and one or more of the components d) to i), if need be supplemented by the previously cited additional polymers and additives. It should be taken into account that corresponding counter ions to the cited ionic components must be present. For example, the molybdate ions and/or tungstate ions are preferably employed as the ammonium or alkali metal salts. However, all in all it is preferred that the corrosion protection composition does not comprise further anions apart from those of the fluoro complexes a) present as anions, the anionic groups in the corrosion protection pigments b) and in the polymer c), the phosphate ions d) as well as the anions of the optional organic compounds f) that are capable of forming chelate complexes. These conditions ensure that after depositing and curing the corrosion protection composition, no salts remain in the coating which are easily soluble in water and which lessen the corrosion protection effect.

In particular, the corrosion protection composition according to the invention should comprise the least possible organic compounds such as for example organic solvents that are volatile under the conditions of baking and which reach the ambient air as “volatile organic carbon” VOC. Accordingly, it is preferred that the corrosion protection composition comprises not more than 5 wt. %, preferably not more than 2 wt. % and especially not more than 0.5 wt. % of organic compounds that have a boiling point at atmospheric pressure below 150° C. to maximum 150° C.

On the grounds of broad applicability, production rate and energy consumption, it is desirable that the metallic substrate with the applied corrosion protection composition be cured at a temperature not exceeding 150° C. Therefore, the organic polymer c) preferably possesses the characteristic that it is curable at a temperature of not more than 150° C., preferably not more than 100° C., within not more than 60 seconds, preferably not more than 30 seconds. The cited temperatures are the substrate temperatures of the metal substrate with the deposited corrosion protection composition.

The above described composition illustrates the corrosion protection composition in ready for use form, in which it can be brought into contact with the metal substrate. In this form, depending on the actual composition, it can exhibit a limited storage stability i.e. over time the formation of a precipitate or a gel can occur. However, in general the ready for use corrosion protection composition is sufficiently stable long enough for it to be employed in the production process. The “pot life”, the time within which the ready for use corrosion protection composition is manipulated, i.e. must be deposited onto the metal substrate, is generally at least 12 hours, preferably at least 24 hours and especially at least 7 days. A significant contribution to this stability is due to the particular selection of the polymer c) as has been previously described. Dispersing additives can also produce a positive effect.

However, the corrosion protection composition is generally not capable of being stored for many weeks or months. Consequently it is preferably supplied and stored in the form of at least two separate solutions or dispersions, which are then first mixed together when they are intended to be used within the previously cited pot life. It is particularly preferred that the first solution or dispersion comprises the corrosion protection pigment b) dispersed in water, preferably together with at least one dispersing additive such as is known, for example, for the grinding of pigment pastes for the manufacture of paints. This solution or dispersion then preferably comprises no polymer c). The second solution or dispersion comprises the polymer c). The component a) and optionally the one or more of the components d) to i) can be present in the first or in the second solution or dispersion. It is preferred in this case if these components are found in the second, polymer-containing solution or dispersion.

The person skilled in the art is aware that the previously cited components, especially the inorganic compounds, can react with one another; accordingly they are present in the treatment solution in the forms that are stable under the cited pH conditions. For example, the fluoro complexes are partially present in the free acid form.

In a further aspect, the present invention relates to a process for coating metallic strips, wherein a corrosion protection composition as previously described is applied in such a thickness onto the moving metallic strip and cured by heating to a temperature of maximum 150° C., preferably maximum 100° C., for a period of maximum 60 seconds, preferably maximum 30 seconds, such that after curing a layer is obtained with a thickness in the range 0.5 to 10 μm, preferably 1 to 5 μm.

For use, especially on metal strip surfaces, the application solution is applied in a known manner by roll coating (Chem-Coating), stripping, dipping/squeezing out or spraying/squeezing out onto a metal strip. The application is preferably made at temperatures between 10 and 50° C., especially between 15 and 35° C. The temperature can be adjusted by heat transfer through the work piece or the treatment solution. Finally, suitable heat transfer simultaneously causes the formation of a film, its crosslinking and anchorage on the metallic surface. For this, peak metal temperatures (PMT) of 50 to 150° C., preferably between 60 and 100° C., are to be reached for a period between 1 and 60 seconds, preferably between 1 and 30 seconds.

The coating with the corrosion protection composition according to the invention represents the first corrosion protection measures. This means that either a freshly produced or a freshly cleaned metal surface that has not been subjected to any corrosion protection measure is brought into contact with the corrosion protection composition according to the invention, and the corrosion protection composition is cured. In this way a metal surface is obtained that has a corrosion protection base coating. The metal strip can be stored and/or shipped in this form. In addition, it can be cut into pieces and optionally shaped and joined together with further pieces into structural units. Metal surfaces that have been coated with the corrosion protection composition according to the invention can also be commercialized and further processed without an additional coating being deposited onto the corrosion protection composition. Depending on the final end use, additional decorative coatings or corrosion protection coatings can be applied once the final metal object has been manufactured.

Alternatively, the metal strip coated with the corrosion protection composition according to the invention or metal sheets cut out of it can be over coated with at least one additional decorative coating or corrosion protection coating such as for example with a paint, before these metal strips or metal sheets are commercialized and/or further processed into sub-assemblies. In this case the corrosion protection composition according to the invention functions as a “primer”.

The process according to the invention is particularly suitable for coating metal strips that are selected from strips of zinc or zinc alloys, aluminum or aluminum alloys as well as steel strips that are coated with zinc or zinc alloys or with aluminum or aluminum alloys. Here, “zinc alloys” or “aluminum alloys” are understood to mean those alloys that consist of more than 50 atom % zinc or aluminum. The steel strips coated with zinc or zinc alloys can have been coated either electrolytically or by the melt dip coating process with zinc or zinc alloys. Here, the zinc alloys deposited on the steel strip can be rich in aluminum or the deposited aluminum alloys can be rich in zinc. Such coated steel strips are known in commerce under the names Galfan® or Galvalume®.

Finally, in a third aspect, the invention relates to a coated metal strip or a metal sheet cut out of this strip, which can be optionally shaped, which has a coating that is obtained according to the inventive process. In this case as well, metal strips or a metal sheet cut out of these strips that are made of the previously listed materials are preferred. According to the embodiments to the inventive processes, the coated metal strip or the metal sheets cut out of the strip can be optionally shaped into a structure, can have that coating obtained according to the inventive process as the sole corrosion protective coating. In this case, the inventive coating is therefore not over coated with an additional decorative or corrosion protective additional layer. However, the invention also relates to a coated metal strip or metal sheet cut out of this metal strip, which can be optionally shaped into sub assemblies and which has at least one additional decorative or corrosion protective coating over the coating obtained according to the inventive process.

1. A chromium-free, curable corrosion protection composition for the initial coating of metal substrates, said composition having a pH in the range 1 to 3, comprising water and
a) fluoro complex ions of titanium and/or zirconium,
b) at least one corrosion protection pigment,
c) at least one organic polymer that is water-soluble or water-dispersible in the cited pH range and which, as such in aqueous solution at a concentration of 50 wt. %, exhibits a pH in the range 1 to 3, where in the organic polymer c)
i) comprises at least two different radically polymerisable, ethylenically unsaturated monomers selected from acrylic acid, methacrylic acid, acrylic acid esters and methacrylic acid esters, wherein at least one monomer selected from acrylic acid esters and methacrylic acid esters is incorporated, and
ii) possesses a fraction of monomers that carry phosphoric acid groups or phosphoric acid ester groups in the polymer in the range of 0.5 to 4 mol %.

2. The corrosion protection composition according to claim 1, additionally comprising
d) phosphate ions.

3. The corrosion protection composition according to claim 1, additional comprising
e) manganese ions and/or magnesium ions,

4. The corrosion protection composition according to claim 1, additionally comprising
f) at least one organic compound that is capable of forming chelate complexes.

5. The corrosion protection composition a according to claim 1, additionally comprising
g) molybdate ions and/or tungstate ions.

6. The corrosion protection composition according to claim 1, additionally comprising
h) at least one cation selected from the group consisting of zinc-, cobalt-, nickel-, vanadium- and iron ions.

7. The corrosion protection composition according to claim 1, additionally comprising
i) at least one reducing agent selected from iron (II) ions and hydroxylamine, hydroxyl ammonium salts or compounds that can split off hydroxylamine.

8. The corrosion protection composition according to claim 1, wherein the corrosion protective pigment b) has cation-exchange properties.

9. The corrosion protection composition according to claim 1, wherein the fraction of monomers that carry phosphoric acid groups or phosphoric acid ester groups in the polymer is in the range of 1 to 2 mol %.

10. The corrosion protection composition according to claim 1, wherein the organic polymer c) exhibits, in addition to phosphoric acid groups or phosphoric acid ester groups, at least one further group selected from epoxy groups, silane groups, carboxyl groups and hydroxyl groups.

11. The corrosion protection composition according to claim 1, wherein the polymer further exhibits carboxylic acid amide groups, wherein at least one hydroxyalkyl group, is bonded to the nitrogen atom of the carboxylic acid amide group.

12. The corrosion protection composition according to claim 1, comprising, in the ready-for-use state, the components in the following proportions in wt. % based on the total corrosion protection composition:
water: 25 to 69.7 wt. %,
a) Fluoro complex ions of titanium and/or zirconium, calculated as the hexafluoro titanic acid or hexafluoro zirconic acid: in total, 0.3 to 3 wt. %,
b) Corrosion protection pigment(s): in total, 5 to 25 wt. %,
c) Organic polymer that is water-soluble or water-dispersible in the cited pH range and which, as such in aqueous solution at a concentration of 50 wt. %, exhibits a pH in the range 1 to 3: in total, 25 to 50 wt. %,
d) Phosphate ions, calculated as phosphoric acid, 0 to 5 wt. %,
e) Manganese ions and/or magnesium ions: in total 0 to 2 wt. %,
f) Organic compound(s) that is (are) capable of forming chelate complexes: in total 0 to 5 wt. %,
g) Molybdate ions and/or tungstate ions, calculated as the ammonium salt: in total 0 to 1 wt. %,
h) Cations selected from zinc, cobalt, nickel, vanadium and iron ions: in total 0 to 1 wt. %,
i) Reducing agent selected from iron (II) ions and hydroxylamine, hydroxyl ammonium salts or compounds that can split off hydroxylamine: in total, 0 to 0.1 wt. %.

13. The corrosion protection composition according to claim 12, comprising not more than 5 wt % of organic compounds that have a boiling point maximum of 150° C. at atmospheric pressure.

14. The corrosion protection composition according to claim 13, wherein, after the water has evaporated, the organic polymer c) is curable within not more than 60 seconds.

15. A process for coating a metal strip, wherein a corrosion protection composition according to claim 1 is applied in such a thickness onto the moving metal strip and cured by heating said metal strip to a temperature of maximum 150° C., for a period of maximum 60 seconds, such that after curing, a layer is obtained with a thickness in the range of 0.5 to 10 μm.

16. The process according to claim 15, wherein the surface of the metal strip is not subjected to any other corrosion protection prior to the application of the corrosion protection.

17. The process according to claim 16, wherein the metal strip is selected from strips of zinc, zinc alloy, aluminum, aluminum alloy or steel coated with zinc, zinc alloy, aluminum or aluminum alloy.

18. An article which comprises a coated metal strip comprising the corrosion protection composition of claim 1.
